(19) United States
(12) Patent Application Publication
(10) Pub. No.: US 2007/0254126 A1
(43) Pub. Date: Nov. 1, 2007

(54) Bottle Label

(76) Inventor: Ben yaacob Lilienthal, Cuajimalpa de morelos D.F. (MX)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/380,282

(22) Filed: Apr. 26, 2006

(51) Int. Cl. B32B 33/00; B42D 15/00

(52) U.S. Cl. 428/40.1; 283/81

(57) ABSTRACT

A three-ply label assembly including a base ply (or underlaminate) and a cover ply (or overlaminate) encapsulating a label ply. The cover ply is adhered to the base ply continuously about the entire perimeter of the label ply to protectively encapsulate the label ply. The label assembly protects printing on the label ply, such as metallic inks particularly susceptible to the recycling process. A method of manufacturing the label assembly also is disclosed.

### BACKGROUND OF THE INVENTION

The present invention relates to labels, and more particularly to labels for recyclable bottles and other objects.

A wide variety of bottles and other objects are recycled in the sense that they are cleaned, sterilized, and refilled. The recycling process may use caustics and other chemicals to clean and sterilize the bottles. Unfortunately, these cleaning solutions degrade the appearance and/or integrity of a label attached to a container. If the label is damaged, then the damaged label must be removed and a new label applied as part of the recycling process. Removal and replacement of labels is unnecessarily expensive and time consuming. Accordingly, artisans have attempted to protect the labels from the cleaning solutions.

One attempt to protect the label includes adhering a clear film, also known as an overlaminate, to the label during the label manufacturing process. The overlaminate is die cut with the label so that their edges are aligned. This approach has been partially successful. The overlaminate prevents the cleaning solutions from directly reaching the face of the label. Unfortunately, the solutions still can attack the edges of the label, entering under the overlaminate. Consequently, this label extends the life of the label for a relatively few cycles.

A second attempt to protect the label includes adhering an overlaminate to the label so that the overlaminate extends beyond the label in all directions. The margin of the overlaminate adheres directly to the bottle around the label to enclose the label between the overlaminate and the bottle. Examples of such protective labels are disclosed in U.S. Pat. No. 3,153,858 to Jones; U.S. Pat. Nos. 2,682,721 and 2,767,495 to Harris; and U.S. Pat. Nos. 5,376,418 and 6,017,408 to Rogers. While this approach protects the label through a greater number of recyclings than the first approach, over time the marginal portion of the overlaminate ultimately will provide an entry point for the cleaning solutions.

### SUMMARY OF THE INVENTION

The aforementioned problems are overcome by the present invention in which a recyclable label includes an underlaminate secured to the overlaminate to protectively encase the label therebetween. More specifically, the label assembly includes a base ply (or underlaminate), a label ply, and a cover ply. The underlaminate and the overlaminate both extend beyond the label in all directions forming marginal portions. The marginal portions of the base and cover adhere to each other to seal and encapsulate the label. The base ply and the cover ply, and the adhesive therebetween are selected to provide an increased amount of precision in the seal and consequently an increased amount of protection to the label.

The label of the present invention extends the number of recyclings a labeled article can sustain before the label degrades to unacceptable levels. Specifically, printing on the label ply, for example metallic inks particularly susceptible to the cleaning solutions, are protectively enclosed between the other two plies.

The invention further includes a method for making the labels. The method starts with a web of clear base film adhered to a continuous release liner. Zones of adhesive are applied to the upper surface of the base film in shapes corresponding to the shapes of the labels to be made. Alternatively, the adhesive can be applied to a web of label material. The label web is brought into contact with the base film web so that the two webs adhere together in the zones of adhesive. The label material is die cut outside each adhesive shape, and the waste matrix is removed to form a plurality of labels. Alternatively, the labels may be precut and placed on the base web. A web of clear cover film, or overlaminate is then adhered over the labels and the base film to protectively encapsulate each label. The overlaminate adheres at least to the base film, and preferably also to the labels. The overlaminate and underlaminate are die cut, and the waste matrix is removed to form a sequence of three-ply labels assemblies on the release liner.

The manufacturing method enables labels of a wide variety of shapes and sizes to be created. Some of those shapes would be difficult, or even impossible, to manufacture using prior art techniques.

These and other objects, advantages, and features of the invention will be more fully understood and appreciated by reference to the description of the current embodiment and the drawings.

### BRIEF DESCRIPTION OF THE DRAWINGS

FIG. 1 is a perspective view of the recyclable label assembly of the present invention on a bottle.

FIG. 2 is an exploded view of the recyclable label assembly.

FIG. 3 is a top plan view of a recyclable label assembly.

FIG. 4 is a sectional view of a recyclable label assembly taken along line IV-IV in FIG. 3.

FIG. 5 is a perspective view showing an intermediate stage of manufacture before the label web is die cut.

FIG. 6 is a perspective view showing an intermediate stage of manufacture after the label web is die cut.

FIG. 7 is a perspective view of the completed recyclable label assemblies on the release liner.

### DESCRIPTION OF THE CURRENT EMBODIMENT

I. Introduction

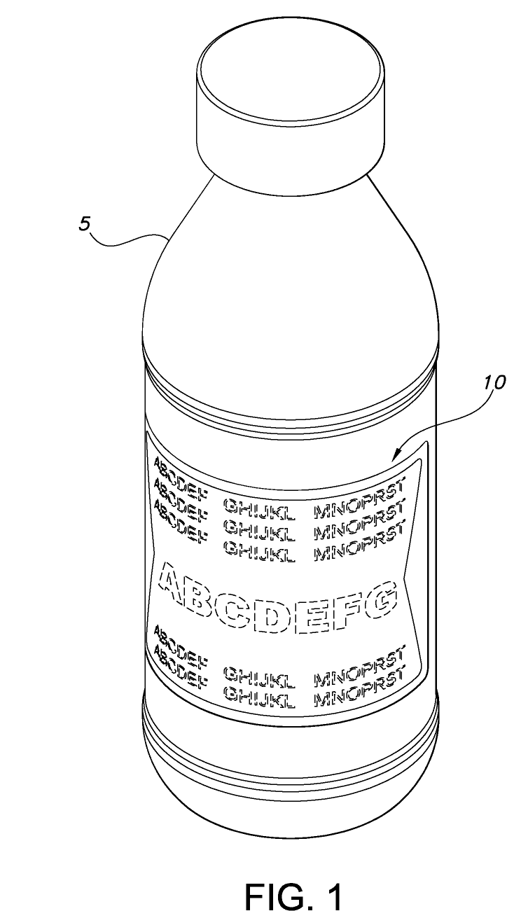

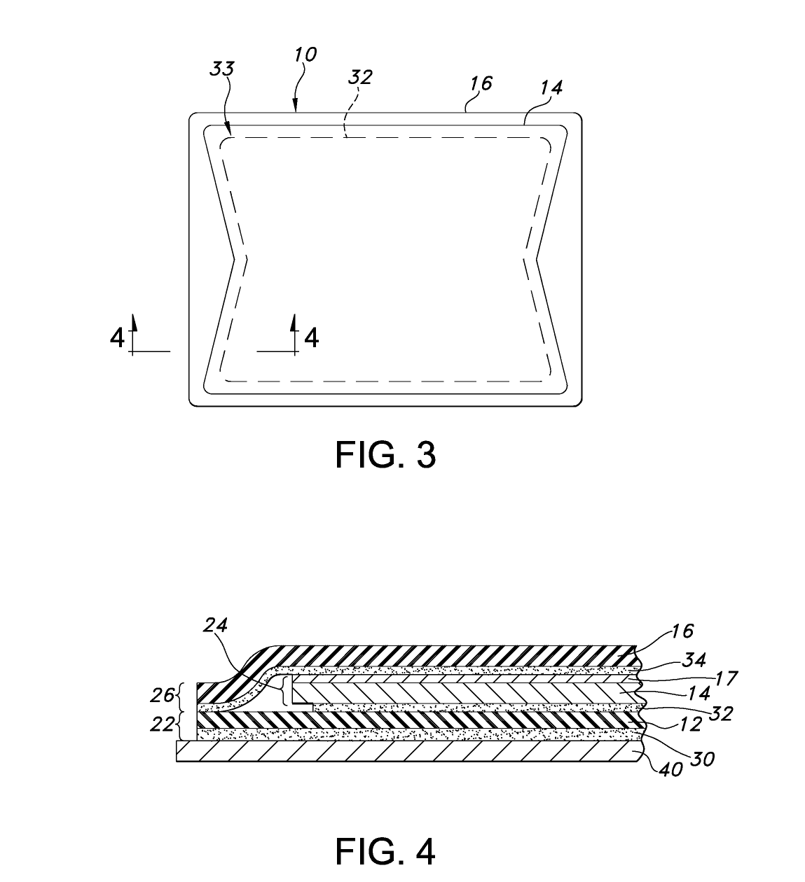

The current embodiment of the recyclable label assembly of the present invention is illustrated in FIGS. 1-4, and generally designated 10. The label assembly 10 may be applied to an article 5, such as a bottle, and includes a bottom or base ply 12, a middle or label ply 14, and a top or cover ply 16 intersecured by adhesives 32, 34. The top and bottom plies 12, 16 extend beyond the label ply 14 in all directions and adhere to one another to encapsulate and protect the middle ply 14.

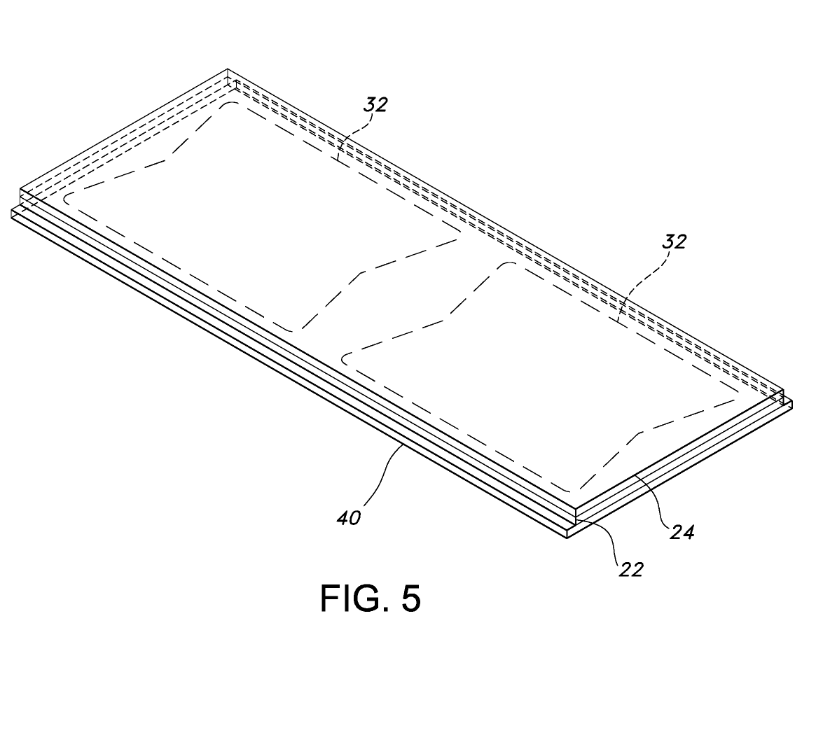

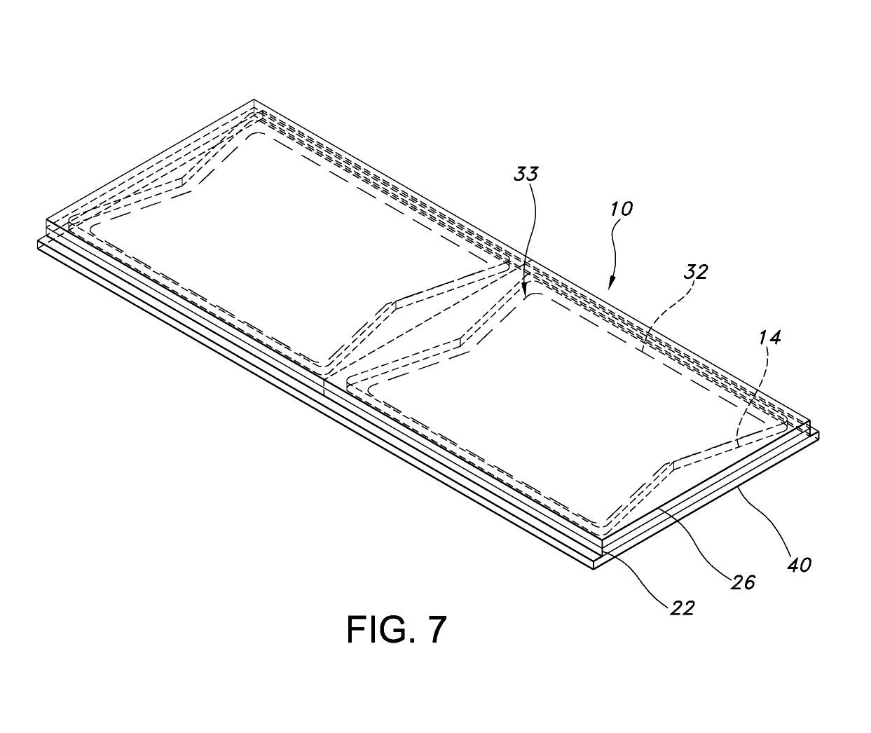

The current embodiment of the method of manufacturing the recyclable label assemblies 10 is illustrated in FIGS. 5-7. The recyclable label assemblies 10 are constructed using a release liner 40, a base web 22, a label web 24, and a cover web 26. The base web 22 includes the base ply 12 and the adhesive 30; the label web includes the label ply 14 and the adhesive 32; and the cover web includes the cover ply 16 and the adhesive 34.

In the current embodiment, the release liner 40, the base web 22, and label web 24 are arranged during the manufacturing process to overlay one another. After the label web 24 is applied to the base web 22, the label web is die cut outside each adhesive shape 32 to form a plurality of labels 14. The cover web or overlaminate 26 is adhered over the labels 14 and the base web 22 to protectively encapsulate each label 14 between the base web and the overlaminate. The base web 22 and the overlaminate 26 are then die cut to form individual label assemblies on the release liner.

II. Label Assembly

The current embodiment is a three-ply recyclable label assembly. However, the recyclable label assembly may contain additional plies.

A. Label Ply

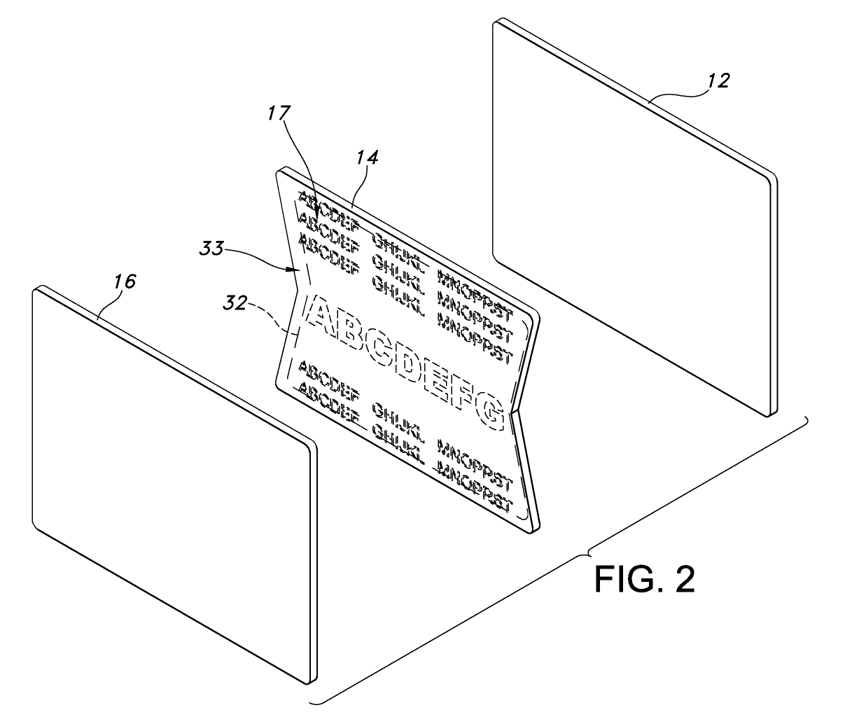

The label ply or layer 14 includes an upper surface and a lower surface and has a shape defined by a perimeter, perhaps as best shown in FIG. 2. The illustrated shape is simply an exemplary shape, and virtually any shape may be selected in view a particular application or requirement. The label ply 14 may be constructed of any suitable material known to those skilled in the art. The current label ply 14 is a metalized plastic film in a generally hourglass shape.

Either or both surfaces of the label ply 14 may be printed. In the current embodiment, an ink layer 17 is applied to the upper surface of the label ply 14. The ink layer 17 may include graphics and/or text. For example, the ink layer 17 may include the product name, description, and/or an ingredient list of the labeled article 5. The ink layer 17 may be constructed and applied using any suitable technique known to those skilled in the art. The ink layer 17 may include one or more metallic inks which are particularly susceptible to the caustic solutions used during the recycling process.

A zone 32 of adhesive is located between the label ply 14 lower surface and the base ply 12 upper surface. The adhesive zone covers all or a portion of the label ply 14 lower surface. In the current embodiment, an adhesive-free margin 33 extends entirely about the perimeter of the label ply. The adhesive may be any suitable adhesive applied in any suitable manner as will be recognized by those skilled in the art. The adhesive zone 32 may cover the entire lower surface of the label ply 14 so that there is no adhesive-free margin. The adhesive 32 intersecures the label ply 14 and the base ply 12.

B. Base Ply or Underlaminate

The base ply or layer 12, sometimes referred to as an underlaminate, extends beyond the label ply 14 in all directions. The base ply 12 may be constructed of film or other suitable material known to those skilled in the art. The current base ply 12 is clear plastic film. The lower surface of the base ply 12 includes pressure sensitive adhesive for temporarily adhering the base ply to a release liner 40, and for ultimately permanently adhering the label assembly to an article 5.

C. Cover Ply or Overlaminate

The cover ply or layer 16, sometimes referred to as an overlaminate, extends beyond the label ply 14 perimeter in all directions. The cover ply 16 may be constructed of any suitable material known to those skilled in the art. The current cover ply 16 is clear plastic film, identical in shape and size to the base ply 12 because the two plies are cut in a single die cut operation. The undersurface of the overlaminate 16 includes an adhesive 34. Accordingly, the overlaminate 16 adheres to the label ply 14; and the overlaminate adheres to the base ply 12 outside of the label ply 14.

III. Manufacture and Use

The recyclable label assemblies 10 currently are fabricated on a continuous web of release liner. Alternatively, the assemblies 10 can be fabricated in sheet form. Initially, the web sandwich includes a base layer web 22 adhered to a release liner web 40 with a pressure sensitive adhesive 30. This initial web can be a purchased component, or it can be created in an initial step of manufacture. A plurality of adhesive shapes 32 or patterns each defining a perimeter are printed or otherwise applied on the upper surface of the base layer 22 at regularly spaced intervals. Alternatively, the adhesive shapes 32 may be applied to the bottom of the label layer 24 instead of to the upper surface of the base layer 22. A label web 24 is then brought into contact with the base layer 22 and the adhesive zones 32 carried thereon resulting in the intermediate form shown in FIG. 5.

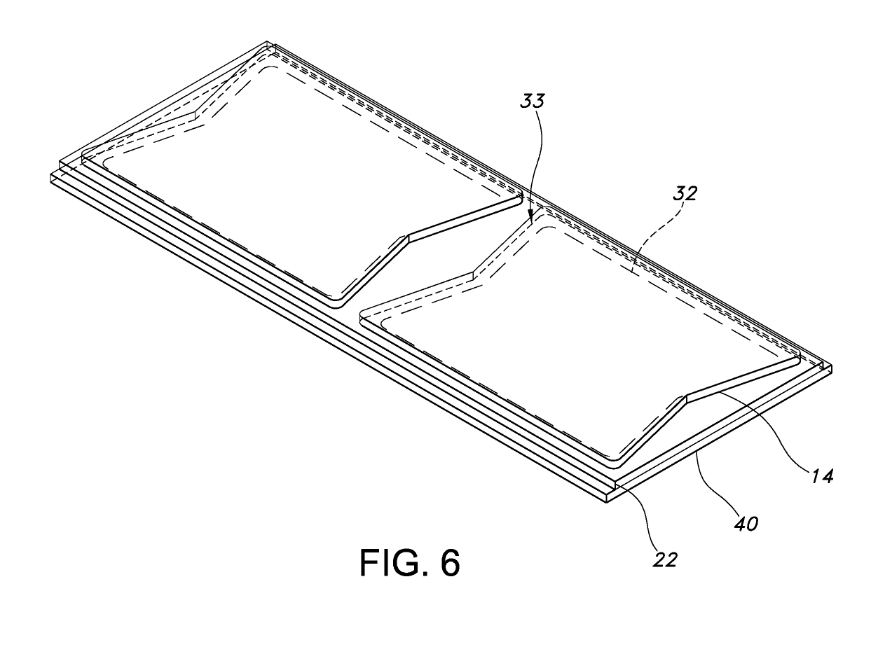

The label ply is then die cut outside the perimeter of each adhesive zone 32 to form a plurality of labels 14, leaving a an adhesive-free margin 33 void of adhesive around the perimeter of each label 14. Alternatively, the die cut is made through the label layer along the perimeter of each adhesive shape 32 leaving no such margin. The waste matrix of label material (not shown) is removed after the die cut leaving a plurality of labels 14 disposed on the base layer 22, resulting in the intermediate form shown in FIG. 6. The adhesive-free margin 33 is preferred because the margin 33 reduces the likelihood of tearing or otherwise damaging the label 14 or the waste matrix when the waste matrix is removed, especially from irregularly shaped labels. Alternatively, the labels 14 can be formed separately from the base web 22 and placed individually on the base web.

An overlaminate web 26 is then applied over the base layer 22 and labels 14. The overlaminate adheres to each label 14. And the adhesive 34 permanently adheres a portion of the cover layer 26 to the base layer 22 encapsulating each label 14 therebetween. The overlaminate 26 and the base layer 22 are then die cut around and outside of the labels 14, to produce a plurality of recyclable label assemblies. The recyclable label assemblies 10 may be provided in roll or other suitable form as known in the art. The recyclable label assemblies 10 may be transferred to the exterior of an article 5 using techniques and apparatuses known in the art. Once transferred, known cleaning techniques may be applied to the article 5 without substantially degrading the integrity of the label.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A label comprising:
a label ply having a shape defining a perimeter;
a base ply having a margin extending beyond said label ply perimeter in all directions;
a cover ply having a margin extending beyond said label ply in all directions, said cover ply and said base ply sandwiching said label ply therebetween;
a first adhesive permanently intersecuring said base ply and said label ply;
a second adhesive intersecuring said cover ply to said label ply and permanently intersecuring said base ply marginal portion and said cover ply marginal portion continuously about the entire perimeter of said label ply, whereby said label ply is protectively encapsulated between said base ply and said cover ply; and
a third adhesive said base ply and for adhering the label assembly to an article.

2. The label of claim 1 further comprising an adhesive free zone between said base ply and said label ply, said adhesive free zone forming a margin about said perimeter.

3.-4. (canceled)

5. The label of claim 1 further comprising a release liner adhered to said base ply by said third adhesive.

6. The label of claim 1 where said base ply, said cover ply, and said first, second, and third adhesives are substantially transparent.

7. The label of claim 1 where said label ply includes printing.

8. A label assembly comprising:
a label layer including a perimeter;
an underlaminate having a marginal portion extending beyond and completely surrounding said label layer perimeter;
an overlaminate having a marginal portion extending beyond and completely surrounding said label layer perimeter, said overlaminate and said underlaminate sandwiching said label layer therebetween;
a first adhesive permanently intersecuring said overlaminate marginal portion to said underlaminate marginal portion entirely around said perimeter of said label layer; and
a second adhesive on said underlaminate adapted to adhere said label assembly to an object.

9. The label assembly of claim 8 further comprising a third adhesive permanently intersecuring said label layer and said underlaminate.

10. The label assembly of claim 8 further comprising a release liner releasably adhered to said underlaminate by said second adhesive.

11. The label assembly of claim 8 wherein said underlaminate and said overlaminate are substantially transparent.

12. The label assembly of claim 8 wherein said label layer includes printing.

13. A method of manufacturing a plurality of label assemblies comprising the steps of:
adhering a base film web to a release liner;
applying intermittent zones of adhesive to at least one of the base film web and a label web;
permanently adhering the label web to the base film web with the zones of adhesive therebetween;
cutting through the label web around each adhesive zone to form a plurality of labels on the base film web, each label having an adhesive zone;
permanently adhering an overlaminate to the base film web and the labels, whereby the base film web and the overlaminate are adhered to one another entirely around each label; and
cutting through said base film and said cover film around and outside of each label to produce a plurality of label assemblies along the length of the release liner, each label protectively enclosed by the permanently adhered cover film and base film.

14. The method of manufacturing a plurality of label assemblies of claim 13 wherein the adhesive zones are applied to the base film web.

15. The method of manufacturing a plurality of label assemblies of claim 13 wherein the base film web and the overlaminate are substantially transparent.

16.-17. (canceled)

18. The method of manufacturing a plurality of label assemblies of claim 13 further comprising removing waste matrices after each cutting step.

19. (canceled)
